(19) United States
(12) Patent Application Publication
(10) Pub. No.: US 2008/0108373 A1
(43) Pub. Date: May 8, 2008

(54) Auto-focused information services tailored to location of end user

(76) Inventors: Anjana Agarwal, Wheaton, IL (US); David S. Benco, Winfield, IL (US); Anne Yin-Fee Lee, Naperville, IL (US); Byron J. Williams, Chicago, IL (US)

Correspondence Address: Lucent Technologies Inc.;Docket Administrator, Room 3J-219, 101 Crawfords Corner Road, Holmdel, NJ, 07733-3030, US

(21) Appl. No.: 11/591,741

(22) Filed: Nov. 2, 2006

(51) Int. Cl. H04Q 7/20

(52) U.S. Cl. 455/456.6

(57) ABSTRACT

Communication networks and methods are disclosed that provide an information service that is tailored (or “auto-focused”) to individual customers or subsets of customers based on the location of those customers. The information service is implemented in one embodiment within a communication network (e.g., IMS network or traditional wireless network) having a presence/location server that maintains presence/location information associated with various customers served by the communication network.

### FIELD OF THE INVENTION

This invention relates generally to communication systems and, more particularly to information-based services in converged communication networks in which information provided to an end user is focused based on the location of the end user.

### BACKGROUND OF THE INVENTION

Information-based services are well known in which an end user may access an information service, for example and without limitation, by calling a designated number (e.g., 1-800-number) or entering a designated code (e.g., star-code) using a wireline or wireless phone or by entering or clicking on a URL (Uniform Resource Locator) from a PC or web-enabled phone to access an information resource on the Internet. Hereinafter, these access numbers, codes, URLs or the like will collectively be referred to as “strings.” Most typically, information-based services are implemented using a common, uniform request string for customers dispersed across a broad geographic area. Often, the strings correspond to a particular topic, product or business so that they may be easily recalled by customers seeking information on that particular topic, product or business. Accordingly, an information content provider associated with a particular string may attract a large volume of customers having similar information needs but from disparate locations. As an example, customers in disparate locations might dial a uniform number 1-800-FLOWERS (or alternatively, they may enter or click on a URL such as flowers.com) to access a florist directory.

It follows, however, that broad-based information services adapted to serve multiple, disparate customers are not equipped to provide tailored information content directed to particular customers or subsets of customers. Rather, the information content tends to have a one-size-fits-all characteristic wherein the same information is provided to every customer, at least initially. For example, depending on implementation, the information content may comprise a generic pre-recorded audio message or a “home” web page having a static display of text and/or images. Following the initial content delivery, a customer may be provided means to focus or refine their search, for example, via operator assistance or by DTMF-tone-driven menus in a telephony implementation or by navigating various hot-links in a web-based implementation. Nevertheless, the burden is on the customer if they wish to focus or refine their search from general to more-specific content.

It is contemplated that customer satisfaction would increase by providing an information-based service that is adapted to provide tailored content to certain individual customers or subsets of customers without relying on customer navigation or redirection from a general content to more specific content.

### SUMMARY OF THE INVENTION

These problems are addressed and a technical advance is achieved in the art by providing an information service that is tailored (or “auto-focused”) to individual customers or subsets of customers based on the location of those customers. The information service is implemented in one embodiment within a communication network (e.g., IMS network or traditional wireless network) having a presence/location server that maintains presence/location information associated with various customers served by the communication network.

In one embodiment, a customer initiates an information service request (e.g., by sending a location non-specific request string). The request is received by a Call Session Control Function (CSCF) and forwarded to a Service Capability Interaction Manager (SCIM) of an IMS network. The SCIM queries a presence/location server to receive presence/location of the customer; and based on the presence/location information, the SCIM redirects or focuses the information service request toward focused information content that is tailored to the customer location. The focused information may comprise, for example, a URL of a location-specific information provider and/or content from the location-specific information provider. Optionally, the SCIM may redirect or focus the information service request externally, via communication with an external information provider; or the SCIM may independently identify or retrieve content from a location-specific provider.

In another embodiment, there is provided an IMS network for providing an information request service that is focused to a customer location. The IMS network includes: a Call Session Control Function (CSCF) element operable to receive a location non-specific information service request and forward the request to a Service Broker; a Service Capability Interaction Manager (SCIM) element operable as Service Broker to focus the information service request to the customer location; and a Presence/Location Server operable to obtain location information of the customer and communicate the location information to the SCUM, the SCIM focusing the information service request based on the location information.

In another embodiment, there is provided an article comprising one or more computer-readable signal-bearing media; and means in the one or more media, responsive to receiving a location non-specific information service request, for receiving presence/location information indicating a customer location and focusing the information service request toward information that is tailored to the customer location.

### BRIEF DESCRIPTION OF THE DRAWINGS

The foregoing and other advantages of the invention will become apparent upon reading the following detailed description and upon reference to the drawings in which:

FIG. 1 is a block diagram of a communication network operable to provide auto-focused information services based on location of an end user in an exemplary embodiment of the invention;

FIG. 2 is a flowchart showing steps for providing auto-focused information services based on location of an end user in an exemplary embodiment of the invention;

FIG. 3 is a flowchart showing alternative modes for redirecting an information service request coincident to providing auto-focused information services based on location of an end user in an exemplary embodiment of the invention; and

FIG. 4 is a message sequence chart associated with providing auto-focused information services based on location of an end user in an exemplary embodiment of the invention.

### DESCRIPTION OF THE PREFERRED EMBODIMENT(S)

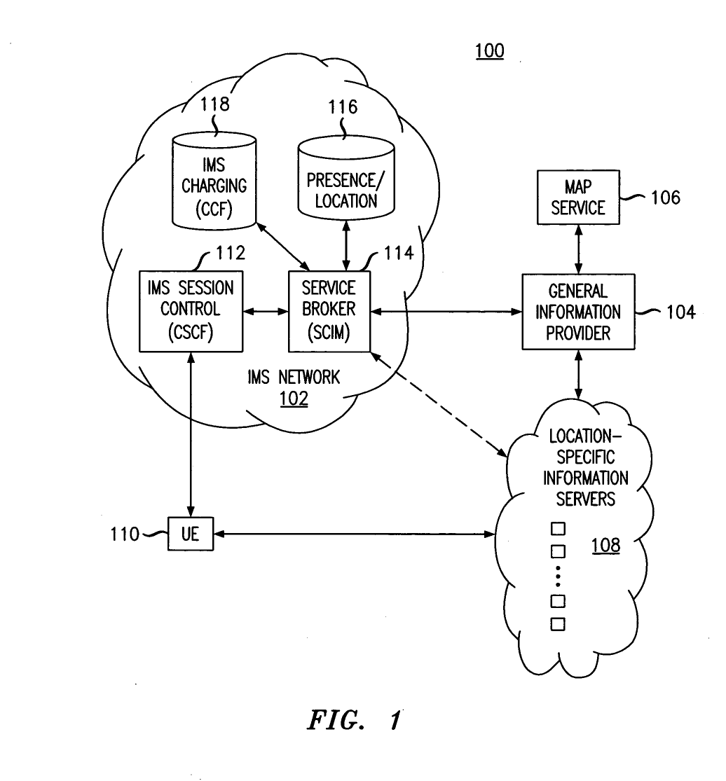

FIGS. 1-4 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates a communication network 100 for providing auto-focused information services based on location of an end user in an exemplary embodiment of the invention. Communication network 100 comprises a serving network 102 (as shown, an IMS network) operably connected to various information content providers including a general information provider 104, a map service 106 and a plurality of location-specific information servers 108. Communication network 100 is adapted to provide auto-focused information services for various customers operating user equipment, or UE 110 (one shown).

The UE 110 may comprise generally any device having capacity to request and receive information content through serving network 102 comprising, for example and without limitation, a mobile phone, wireline phone, a PDA, VoIP phone or SIP phone, laptop or desktop computer. The UE may employ user interfaces including, without limitation, numeric or alpha-numeric keypads, keyboards, text displays, audio-visual displays and the like to request and receive information content through serving network 102.

The serving network 102 comprises generally any network operable to receive the information requests from the UE 110 and, based on location of the UE, redirect the information request to provide specific information content tailored to the UE 110. The serving network 102 may comprise, without limitation, an IP Multimedia Subsystem (IMS) network, a wireless network (e.g., CDMA-based or GSM-based network), a circuit-switched network, a packet-based network (IP network) or another type of network.

In the embodiment of FIG. 1, the serving network comprises an IMS network 102. Generally, an IMS network is a next-generation architecture for providing a combination of mobile and fixed multimedia services. IMS allows operators to provide virtually any IP-based service to fixed, mobile or wireless customers. As shown, the elements of the IMS network 102 include a CSCF 112 (Call Session Control Function), a SCIM 114 (Service Capability Interaction Manager), a Presence/Location Server 116 and a CCF 118 (Charging Collection Function). As will be appreciated, each of these elements are functional elements that may reside individually or collectively in one or more physical structures or may be implemented in software. Further, the elements may take different forms depending on the network topology of the serving network 102. For example, in a wireless network, the function of the CSCF 112 may be accomplished by a switching element such as a Mobile Switching Center (MSC).

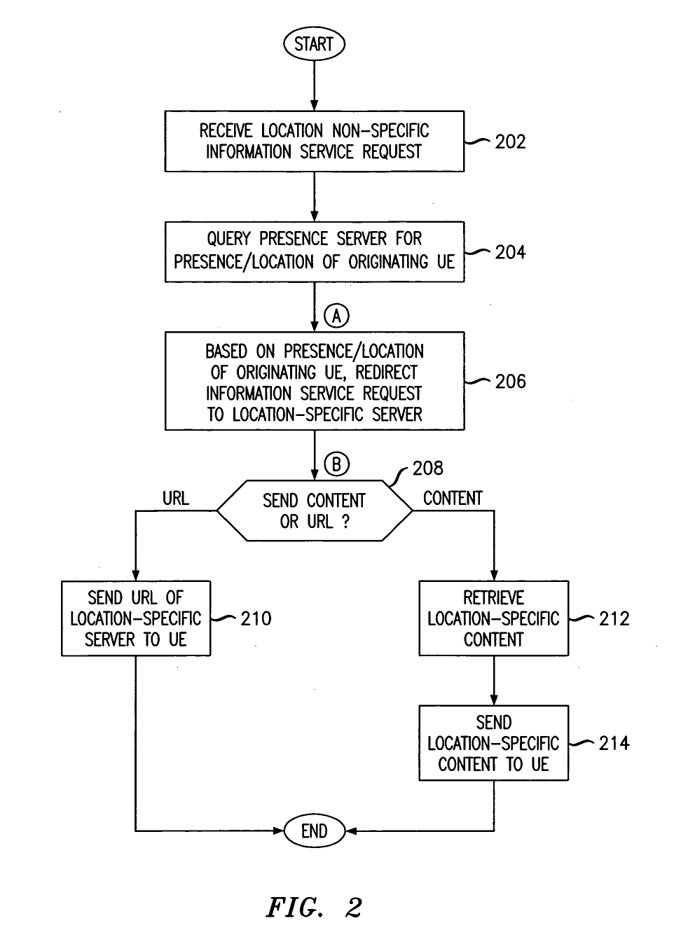

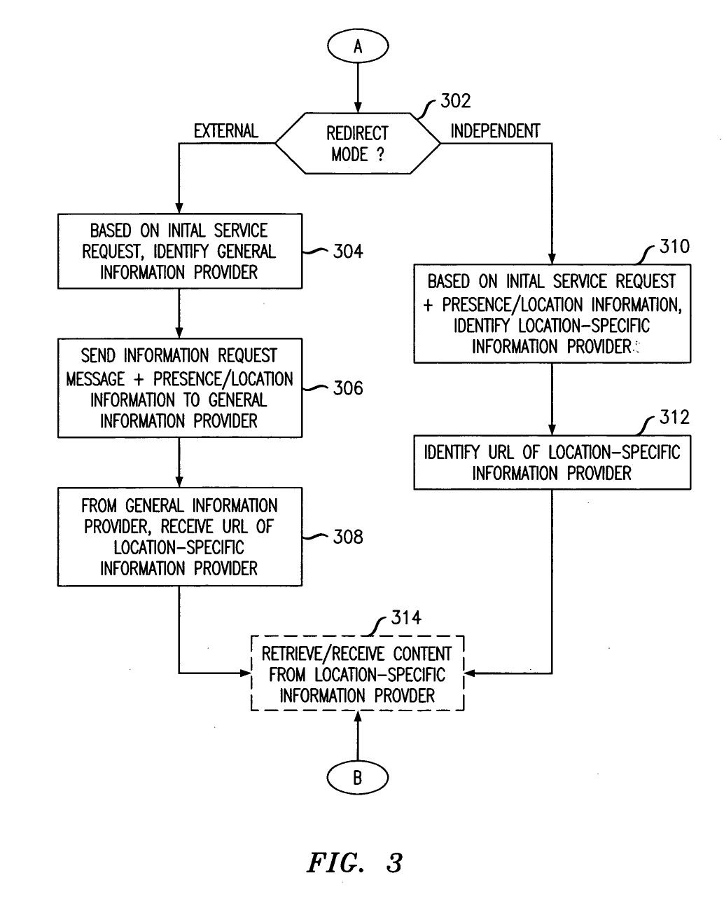

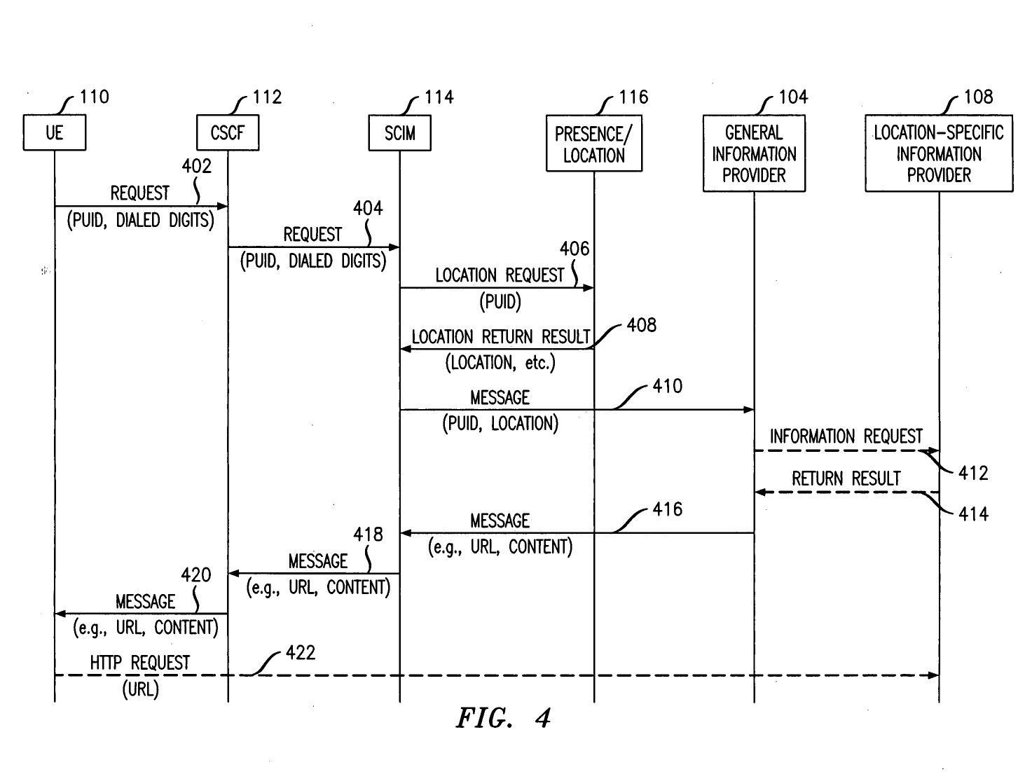

The CSCF 112 operates to provide IMS Session Control, which includes managing user registrations, inspecting incoming messages and directing messages to an appropriate application server(s). The SCIM 114 is an application server operating as a Service Broker for Information Services. The Presence/Location Server is an application server that is adapted to identify presence/location attributes of users including, without limitation, location estimates (horizontal and vertical), direction of travel and/or velocity estimates so as to enable location-based services to UE 110. The CCF manages charging/billing for IMS-based services. The CSCF 112, SCIM 114, presence/location server 116 and CCF 118 operate collectively with the general and location-specific information providers 104, 108 to provide auto-focused information services for UE 110, as will be described in greater detail in relation to FIG. 2, FIG. 3 and FIG. 4.

The general and location-specific information providers 104, 108 comprise generally, any company, organization or entity or combination thereof that produces or distributes general information content and location-specific information content, respectively. As will be appreciated, the general and location-specific information providers 104, 108 are functional entities that may reside in the same or different companies, organizations or entities. The information content provided by general and location-specific information providers 104, 108 may comprise, without limitation, audio, video, text, data or signaling that conveys general or location-specific information, respectively. General information may be defined as relatively broad-based information content that is applicable to customers dispersed across multiple locations; whereas location-specific information comprises information content that is directed toward customers at specific locations or areas. For example, in the context of a web-based information service, general information content may comprise a home web page of a broad-based business; whereas location-specific information content may comprise a web page associated with a particular branch or affiliate of the business serving a designated area.

The map service 106 is an information provider that is particularly adapted to provide content including maps, directions and so forth. In one embodiment, the general information provider consults with the map service 106 to obtain general or location-specific map content and provides such content (or alternatively, provide a URL to access such content) to a customer via the SCIM 114 in conjunction with serving an information service request.

Turning to FIG. 2, there is shown a flowchart that may be implemented in a communication system of the type shown in FIG. 1 to provide auto-focused information services tailored to the location of mobile or fixed customers. In one embodiment, the steps of FIG. 2 are implemented using stored software routines within the SCIM 114 (“Service Broker”) of the IMS network 102. The steps of FIG. 2 may be implemented on any computer-readable signal-bearing media residing within the SCIM 114 or other platforms of the IMS network 102. As will be appreciated, however, the method is not limited to the IMS network 102 or elements of FIG. 1. The computer-readable signal-bearing media may comprise, for example and without limitation, floppy disks, magnetic tapes, CD-ROMs, DVD-ROMs, hard disk drives or electronic memory. The computer-readable signal-bearing media store software, firmware and/or assembly language for performing one or more functions relating to FIG. 2.

The method presumes that a customer operating UE 110 initiates an information service request by sending a request string (e.g., 1-800-number or URL) associated with a general information provider 104. The CSCF 112 receives the request string, recognizes it as an information service request and forwards it to the SCIM 114. The SCIM 114 receives the information service request at step 202. The request is indicated as a “location non-specific” information service request since it is initiated using a request string that is non-specific to any particular location; or stated differently, the same request string may be used by customers at different locations.

At step 204, the SCIM 114 queries the presence/location server 116 so as to request and receive presence/location information associated with UE 110. At step 206, the SCIM 114 operates to focus or redirect the information service request, based on the presence/location information associated with UE 110, to facilitate providing location-specific information to UE 110. As will be described in greater detail in relation to FIG. 3, step 206 may be accomplished externally (via communication with general information provider 104) or independently by the SCIM 114.

In one embodiment, step 206 results in the SCIM 114 receiving a URL and/or information content associated with a location-specific information server 108. At step 208, the SCIM 114 determines whether to send a URL or information content to the UE 110. In the case where a URL is to be provided, the SCIM 114 sends a URL associated with an appropriate location-specific server 108 to the UE 110 at step 210. In the case where information content is to be provided, the SCIM 114 retrieves location-specific content at step 212 and sends the information content to the UE 110 at step 214. The information content may comprise, for example and without limitation, an audio, video, text or multimedia message, web page, map/direction data and so forth.

The UE 110 receives the URL and/or information content via the CSCF 112. Thereafter, the UE can access the URL (or simply view the provided content, where applicable) to obtain focused information that is tailored to the UE location. The information is said to be “auto-focused” since it is focused to the UE location by operation of the SCIM 114 and/or information providers 104, 108 (i.e., without relying on the UE customer to focus the search).

Now turning to FIG. 3, alternative modes are shown for the SCIM 114 to redirect the information service request. In one embodiment, similar to FIG. 2, the steps of FIG. 3 are implemented using stored software routines within the SCIM 114 of the IMS network 102. The steps of FIG. 3 may be implemented on any computer-readable signal-bearing media residing within the SCIM 114 or other platforms of the IMS network 102.

At step 302, the SCIM 114 determines whether to use an external or independent mode to serve the information service request. In the external mode, the SCIM 114 communicates with a general information provider 104 to redirect the information service request; whereas in the independent mode, the SCIM 114 redirects the information service request without relying on a general information provider 104.

In the case where the SCIM 114 chooses the external mode, the SCIM at step 304 selects a general information provider 104 to assist the information service request. In one embodiment, the SCIM 114 identifies a general information provider 104 based on the request string (e.g., 1-800-number or URL) entered by the UE 110. At step 306, the SCIM 114 sends an information request message to the selected general information provider 104 that includes presence/location information associated with the originating UE 110. (Recall that the SCIM 114 received presence/location information associated with the UE 110 at step 204, FIG. 2.) In one embodiment, based on the presence/location information, the general information provider 104 identifies and provides a URL associated with a location-specific information server 108. The SCIM 114 receives the URL of the location-specific information server 108 at step 308. Alternatively or additionally, the general information provider 104 may access and deliver general or location-specific information content to the SCIM 114 at step 308. Optionally, the SCIM at step 314 may itself access the URL and retrieve content from the location-specific information server 108.

In the case where the SCIM 114 chooses the independent mode, the SCIM independently (i.e., without assistance from a general information provider 104) identifies a location-specific information provider 108 at step 310; and the SCIM 114 identifies a URL of the location-specific information server 108 at step 312. Optionally, at step 314, the SCIM may access the URL and retrieve content from the location-specific information server 108.

FIG. 4 is a message sequence diagram illustrating messaging in IMS network 102 to provide auto-focused information services, accomplished in external mode (i.e., with assistance of a general information provider 104) in an exemplary embodiment of the invention. The messages of FIG. 4 comprise SIP messages since IMS is a SIP-based network.

The message sequence is initiated by UE 110 sending an information service request message 402 to the CSCF 112. The message 402 includes a PUID (Public User ID) field that uniquely identifies the UE 110. The message further includes a request string (e.g., comprising dialed digits) associated with a general information provider 104. Responsive to message 402, the CSCF 112 recognizes the message as information service request and forwards message 404 to the SCIM 114. In one embodiment, message 404 includes the same PUID and dialed digits as the initial request message 402.

Responsive to receiving message 404, SCIM 114 sends a location request message 406 to presence/location server 116 to query for presence/location information associated with UE 110. The message 406 includes the PUID of the UE 110 so that the presence/location server knows to retrieve location information specific to UE 110. The presence/location server 116 then retrieves location information specific to UE 110 and sends a return result message 408 to SCIM 114 that includes retrieved location data associated with UE 110.

Next, the SCIM 114 selects a general information provider 104 and sends an information request message 410 to the selected general information provider 104. In one embodiment, the message 410 includes the PUID and location data associated with the originating UE 110. Based on the presence/location information, the general information provider 104 identifies a URL and/or content associated with a location-specific information server 108. The general information provider may obtain the URL and/or content independently or via optional message sequence 412, 414 with location-specific information provider 108. The general information provider sends the URL and/or content to the SCIM 114 via message 416.

SCIM 114 sends message 418 including the location-specific URL and/or content to CSCF 112; and CSCF 112 delivers the URL and/or content to UE 110 via message 420. Thereafter, the UE accesses the URL via HTTP request 422. In such manner, the UE 110 obtains focused information that is tailored to the UE location while placing relatively little burden on the UE operator.

### EXAMPLES

The following examples illustrate the advantages of auto-focused information services as described herein.

### Example 1

A subscriber residing or visiting in City A wishes to send his wife flowers for their anniversary. Using the IMS client on his mobile handset, the subscriber dials the uniform number 1-800-FLOWERS, nominally associated with a national florist service. The IMS system 102 recognizes the request as an information service request and identifies the location of the subscriber as within City A, then redirects the information service request to identify a URL of a florist within City A. The subscriber accesses the URL to enter a web page specific to the City A florist; and browses the web page to select and place an order. Optionally, the subscriber can exercise an option to get a map/directions to the City A florist if he wishes to pick up the order. Still further, the subscriber may exercise an option to charge the order to his cell phone bill.

### Example 2

A subscriber visiting in City B wishes to obtain tourist information associated with City B. The subscriber initiates an information request by dialing a nation-wide tourist information number 1-800-VISITOR. The IMS system 102 recognizes the request as an information service request initiated from City B; and provides the subscriber with tourist information content unique to City B that is displayed on the subscriber's handset. From the display, the subscriber may navigate to more specific content (e.g., a list of museums). By selecting a specific museum, additional information (such as hours of operation) can be obtained. Optionally, the subscriber might click on a “call” icon to set up a call to the selected museum.

### Example 3

A subscriber traveling north on Avenue C wishes to obtain a list of available movies in his location. The subscriber dials a broad-based movie information service (e.g., 1-800-MOVIES) and the request is received by IMS system 102. The IMS system 102 sends the subscriber a list of local theaters, movies and show times tailored to the subscriber's location and direction of travel. The subscriber may select a movie from the list to view a trailer, read a review, etc.

The specific exemplary embodiments of the present invention have been described with some aspects simplified or omitted. Those skilled in the art will appreciate variations from these embodiments that fall within the scope of the invention. The described embodiments are to be considered in all respects only as illustrative and not restrictive. The invention may be deployed in generally any wireline, wireless or IMS network including those with network topologies that differ from FIG. 1 or that use message sequences other than shown in FIG. 4. The scope of the invention is, therefore, indicated by the appended claims rather than by the foregoing description. All changes that come within the meaning and range of equivalency of the claims are to be embraced within their scope.

What is claimed is:

1. A method comprising:
receiving an information service request initiated by a customer;
receiving presence/location information indicating at least a location of the customer, defining a customer location;
focusing the information service request toward information that is tailored to the customer location, defining focused information content; and
sending at least indicia of the focused information content to the customer.

2. The method of claim 1, wherein the step of receiving an information service request comprises receiving a request string associated with a general information provider, defining a location non-specific request string.

3. The method of claim 1, wherein the step of sending at least indicia of the focused information content comprises sending the customer a URL of a location-specific information server maintaining the focused information content.

4. The method of claim 1, wherein the step of sending at least indicia of the focused information content comprises sending the customer one or more items of focused information content.

5. The method of claim 1, performed by a Service Capability Interaction Manager (SCIM) of an IMS network serving the information service request.

6. The method of claim 5, wherein the step of receiving presence/location information comprises the SCIM querying a presence/location application server of the IMS network.

7. The method of claim 5, wherein the step of focusing the information service request comprises the SCIM performing steps of:
identifying an external information provider to assist in focusing the information service request;
sending, to the external information provider, the presence/location information associated with the customer; and
receiving, from the external information provider, a URL of a location-specific information server maintaining one or more items of focused information content tailored to the customer location.

8. The method of claim 5, wherein the step of focusing the information service request comprises the SCIM performing steps of:
identifying an external information provider to assist in focusing the information service request;
sending, to the external information provider, the presence/location information associated with the customer; and
receiving, from the external information provider, one or more items of focused information content tailored to the customer location.

9. The method of claim 5, wherein the step of focusing the information service request comprises the SCIM identifying a URL of a location-specific information server maintaining one or more items of focused information content.

10. The method of claim 9, further comprising the SCIM obtaining, from the location-specific information provider, one or more items of the focused information content.

11. An IMS network for providing an information request service that is focused to a customer location, the IMS network comprising:
a Call Session Control Function (CSCF) element operable to receive a location non-specific information service request and forward the request to a Service Broker;
a Service Capability Interaction Manager (SCIM) element operable as Service Broker to focus the information service request to the customer location; and
a Presence/Location Server operable to obtain location information of the customer and communicate the location information to the SCIM, the SCIM focusing the information service request based on the location information.

12. An article comprising:
one or more computer-readable signal-bearing media; and
means in the one or more media, responsive to receiving a location non-specific information service request, for receiving presence/location information indicating a customer location and focusing the information service request toward information that is tailored to the customer location.
